(19) United States
(12) Patent Application Publication
(10) Pub. No.: US 2026/0080024 A1
(43) Pub. Date: Mar. 19, 2026

(54) TECHNIQUES FOR ENHANCING LANGUAGE MODEL CAPABILITIES

(71) Applicant: OPTUM, INC., Minnetonka, MN (US)

(72) Inventors: Hui Xie, Grasonville, MD (US); Feili Yu, Shoreline, WA (US)

(21) Appl. No.: 18/890,287

(22) Filed: Sep. 19, 2024

(51) Int. Cl. G06F 16/955

(52) U.S. Cl. CPC G06F 16/955

(57) ABSTRACT

Techniques for enhancing language model capabilities are disclosed herein. An example computer-implemented method comprises receiving an input prompt comprising textual data and generating output data by a large language model (LLM) based at least in part on the input prompt. The output data includes a file identifier associated with a file stored in a storage location. The example computer-implemented method further comprises retrieving, based on the file identifier, a file resource identifier that indicates the storage location and replacing the file identifier within the output data into the file resource identifier. The example computer-implemented method further comprises causing the output data to be displayed to a user, which includes causing an image associated with the file resource identifier to be displayed.

### TECHNICAL FIELD

The present disclosure generally relates to language models, and more particularly, to enhancing language model capabilities by causing the language models to generate resource identifiers that reference images.

### BACKGROUND

Large language models (LLMs) have gained traction in a wide variety of industries and use-cases. A first type of these models may be limited to receiving text-based inputs (i.e., prompts) and outputting text-based responses. An example use-case for LLMs involves training/utilizing an LLM as a chatbot to receive text-based prompts from users seeking information related to an entity (e.g., a service provider) and to output text-based responses with relevant information.

However, in many circumstances, images and other non-textual data substantially enhance response quality by providing users with additional or alternative means to understand/interpret the requested information. For example, enterprise flowcharts effectively illustrate complicated relationships that, if represented in text, would be significantly less comprehensible. Thus, as this first type of LLMs are generally unable to output non-textual data, these LLMs frequently provide outputs lacking interpretability.

Further, multi-modal LLM (MLLMs) architectures fail to overcome these challenges. These MLLMs typically leverage process input data in first modalities (e.g., text, image) and generate an output in second modalities (e.g., text, image, video, audio), where the number of first modalities may be a single or multiple modalities and the first and second modalities include one or more modalities that are different. However, the images generated by such models are afflicted by high hallucination rates and overly symbolize the inputs. For example, returning to the enterprise flowchart example, if an input prompt to such a model comprised text requesting an image of a particular organization's enterprise flowchart, an MLLM may generate an image generally related to enterprise flowcharts, business meetings, a depiction of common visual features related to the organization, etc. Any text appearing in such an image may be wildly inaccurate and/or full of various visual artifacts, such as incomplete letters, misspelled words, overlapping letters, etc.

Other systems attempting to overcome these challenges include pairing an LLM with another model configured to generate images or other non-textual outputs, but such configurations also suffer from several drawbacks. For example, image reconstruction/generation models typically analyze image data at a pixel-by-pixel level, and consequently occupy significant processing resources to output an image in combination with textual data output by the LLM. Further, although such hybrid models may achieve slightly better results than MLLMs, the results may still be highly inaccurate and may include numerous hallucinations.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIG. 2 depicts an example language model multimedia output workflow, in accordance with various embodiments described herein.

FIG. 3 depicts an example language model output data generation and multimedia data replacement process, in accordance with various embodiments described herein.

FIG. 4 depicts a flow diagram representing an example computer-implemented method, in accordance with various embodiments described herein.

### DETAILED DESCRIPTION

Broadly speaking, the enhanced language model techniques of the present disclosure enable LLMs to efficiently output non-textual data by generating file resource identifiers within LLM output data. More specifically, the techniques of the present disclosure include an LLM trained to use an input prompt to generate output data that includes a file identifier associated with an image. The techniques of the present disclosure then retrieve, based on the file identifier, an file resource identifier (e.g., a uniform resource locator (URL)) that indicates a storage location and replace the file identifier within the output data into the file resource identifier. The techniques of the present disclosure improve LLMs techniques at least by: (1) enhancing the output capabilities of LLMs that are not incorporated in or operate in conjunction with any additional/complementary models (e.g., image reconstruction/generation models) to include non-textual data, and (2) generating such non-textual data more efficiently than previous techniques.

Moreover, as previously mentioned, non-textual outputs (e.g., images) often increase/enhance the information conveyed to and/or otherwise received by users. Former LLMs without complementary models (e.g., image reconstruction/generation models) and/or MLLMs are unable to provide such non-textual outputs, and therefore suffer from reduced output interpretability. Moreover, former LLMs coupled with a complementary model typically analyze image data at a pixel-by-pixel level to perform image reconstruction/recreation, which may use significant processing resources (e.g., processing cycles, time, energy).

By contrast, the techniques of the present disclosure enable an LLM to provide such non-textual outputs without any additional models and may reduce processing resource use, thereby decreasing the computing load, time to output generation, energy usage, etc. Moreover, the output data achieved by the techniques described herein may reduce or eliminate hallucination and accordingly increase the accuracy of outputs of an LLM. Specifically, the techniques of the present disclosure avoid the pixel-by-pixel image reconstruction/generation of former techniques by retrieving a file resource identifier and converting the file identifier in the LLM output data to the file resource identifier to enable a user to access/view the image.

In this manner, the techniques of the present disclosure enable an LLM to output non-textual data (e.g., images) as part of a generated response while simultaneously avoiding processor intensive image reconstruction/generation, which former techniques are unable to accomplish. The techniques of the present disclosure therefore improve the functioning of a computer by (1) improving the output capabilities of an LLM and (2) decreasing processing resources required to provide non-textual data in outputs from the LLM.

More specifically, the techniques of the present disclosure improve the functionality of a computing device (e.g., a hosting server such as a central server) at least by processing data in a particular way to enhance the efficiency and capabilities of the computing device. The LLM, executing on the computing device, generates output data including a file identifier that the systems of the present disclosure convert into an associated file resource identifier with an efficiency not achieved using former techniques. That is, the present disclosure describes improvements in the functioning of the computer itself because the computing device more efficiently processes data as a direct result of application of the techniques discussed herein, including.

Still further, the present disclosure includes specific features other than what is well-understood, routine, conventional activity in the field, and/or unconventional operations that demonstrate, in various embodiments, particular useful applications, e.g., generating, by the one or more processors, output data by processing the input prompt using a large language model (LLM), the output data including a file identifier associated with a file stored in a storage location; retrieving, by the one or more processors and based on the file identifier, an file resource identifier that indicates the storage location; and/or converting, by the one or more processors, the file identifier within the output data into the file resource identifier, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art.

### Example Computing System

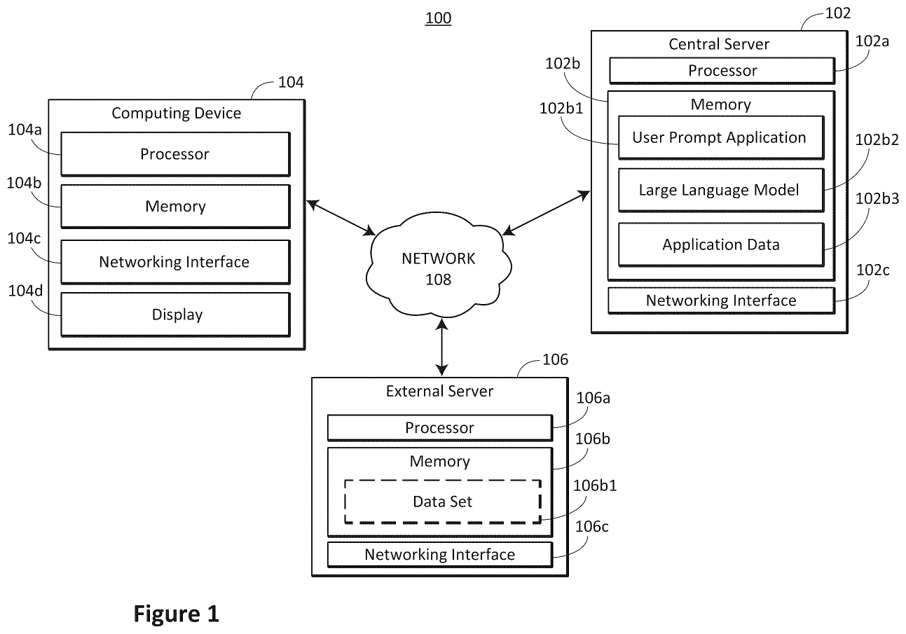

FIG. 1 depicts an example computing system 100 in which various embodiments of the present disclosure may be implemented. Depending on the embodiment, the example computing system 100 may determine/generate output data, file identifiers, file resource identifiers, images, and/or any related values or combinations thereof. Of course, it should be appreciated that, while the various components of the example computing system 100 (e.g., central server 102, computing device 104, external server 106, etc.) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the central server 102 and/or the external server 106 belong to a service providing entity that has produced a variety of documents, files, and/or other reference information associated with their services, and the computing device 104 belongs to a user attempting to interact with the service providing entity. In this example, the user using the computing device 104 may transmit an input prompt to the central server 102, and the server 102 may execute a user prompt application 102b1 to generate output data including textual data and/or non-textual data (e.g., image data) from the reference information and/or otherwise indicating such data as a response to the user's input prompt. The central server 102 may also make the output data accessible to the user via the computing device 104, so the user may review the output data to review the data included therein, provide a subsequent input prompt, and/or any other suitable actions or combinations thereof.

More specifically, the central server 102 includes one or more processors 102a, the memory 102b, and a networking interface 102c. The memory 102b stores executable instructions that are configured to, when executed by the one or more processors 102a, cause the one or more processors 102a to analyze data (e.g., input prompts, application data 102b3, data set 106b1) received at the central server 102 and output various values (e.g., output data). The user prompt application 102b1, the LLM 102b2, and the application data 102b3 may all include such executable instructions, as well as other data. The memory 102b may also store additional data and/or databases. It should be appreciated that the central server 102 can include one or multiple computing devices that are co-located or distributed. Additionally, in certain embodiments, the user prompt application 102b1 comprises the LLM 102b2.

In some examples, the user prompt application 102b1 may comprise an encoder model, such as Word2Vec, bidirectional encoder representations from transformers (BERT), sentence BERT (SBERT), t-distributed stochastic neighbor embedding (t-SNE), and/or the like. In some examples, the LLM may comprise a transformer-based machine-learned model and may comprise an encoder (e.g., the encoder model discussed above or an additional or alternate encoder) and/or one or more decoder(s). In some examples, the LLM may comprise a decoder-only transformer-based architecture, such as generative pretrained transformer (GPT)-3, GPT-3.5, and/or the like. Additionally or alternatively, the LLM may comprise an additional or alternate non-transformer-based architecture, such as a neural network, Komogorov-Arnold Network (KAN), or any other classifier.

In some examples, the encoder and/or decoder may be trained together or separately. In some examples, the training may comprise a first stage where the encoder is trained using reconstruction loss training. Reconstruction loss training may comprise providing a training input (e.g., a text string) as input to the encoder; determining, by the encoder and using the training input, a training embedding; providing the training embedding as input to a training decoder; determining, by the training decoder and using the training embedding, an estimated reconstruction of the training input; determining, by a loss function, a loss determined based at least in part on a difference between the estimated reconstruction and the training input; and altering one or more parameters of the encoder and/or the training decoder to reduce the loss by a loss optimization algorithm (e.g., gradient descent). Once training is completed or stopped (e.g., the training processed a specified number of batches or epochs, the average loss determined for the last n training inputs is below a threshold loss (where n is a positive integer)), the training decoder may be removed or output from the encoder may no longer by provided to the training decoder.

In a second stage of training or if the encoder is a pre-trained encoder, such as one of the SentenceTransformers, the LLM decoder may be associated with the encoder and trained. In some examples, the second stage of training may comprise freezing the parameter(s) associated with the encoder and only tuning the parameter(s) of the LLM, although in additional or alternate examples, the second stage of training may comprise backpropagating loss(es) determined during the second stage of training through the encoder and decoder. In some examples, the second stage of training may comprise contrastive loss training (e.g., using positive output examples and negative output examples to determine a loss), reinforcement learning from human feedback (e.g., using labels associated with the decoder output indicating whether the output was accurate/acceptable), and/or the like. In some examples, the second stage of training may be ongoing, such as by conducting the second stage of training upon receiving a sufficient number of contrastive examples, labels, or the like to form a batch of training data. For example, once a specified number of input-output pairs and positive/negative examples and/or labels have been received, the second stage of training may be executed.

In some examples, the LLM 102b2 may include hyperparameter settings tuned to increase output predictability, such as by using a temperature below 1.0, a stop sequence that indicates a token number limit the LLM is permitted to output, and/or presence and/or frequency parameters.

The central server 102 receives an input prompt from the computing device 104 connected to the server 102 through a network 108 and processes the input prompt in accordance with one or more sets of instructions stored in a memory 102b to output any of the values described herein. The central server 102 executes the user prompt application 102b1, which in turn, accesses and applies the LLM 102b2, and/or the application data 102b3 to the input prompt. The LLM 102b2 then generates output data that represents a response to the input prompt, and the output data includes a file identifier associated with an image. The user prompt application 102b1 identifies the file identifier within the output data, locates the file resource identifier and/or other data indicated by the file identifier, and converts the file identifier in the output data to the file resource identifier, the image, and/or other data. In this manner, the output data displayed to the user allows the user to access the image through the file resource identifier and/or includes the image directly along with any other textual data output by the LLM 102b2.

The input prompt generally comprises textual data. In some embodiments, the input prompt may include non-textual data, such as image data, audio data, and/or any other suitable data type(s) or combinations thereof. For example, the input prompt may include a text string, an audio stream, a video stream, a file, a document, and/or any other suitable data/datatype(s) or combinations thereof.

The file identifier comprises a text string that generally references an image that is extracted from a document and stored in a storage location (e.g., application data 102b3, data set 106b1). The file identifier indicates and/or is otherwise associated with the file resource identifier, such that the user prompt application 102b2 can retrieve the file resource identifier when the file identifier is present in LLM 102b2 outputs. The file identifier may be embedded into the context provided to the LLM 102b2 as part of an input prompt, and the LLM 102b2 may thereby output textual data that includes the file identifier.

The file resource identifier comprises a text string that indicates the storage location of an image, an audio file, a video file, a three-dimensional model, an executable file, an application file, and/or any other suitable data file/type or combinations thereof included and/or referenced in a file, document, and/or other resource (e.g., .pdf file, .doc file, .docx file, website, online article). For example, the file resource identifier may reference a storage location of an image that was extracted from a .pdf file that is contextually relevant to text included in the output data from the LLM 102b2. In some embodiments, the file resource identifier comprises a uniform resource locator (URL) or a uniform resource identifier (URI), that links/directs the user prompt application 102b1 to a storage location (e.g., application data 102b3, data set 106b1) that includes the image and/or other non-textual data.

For example, the file identifier for an image may be “UserGuide_Figure_3,” and the corresponding file resource identifier may be the uniform resource identifier (URI) “storagelocation/UserGuide_Figure_3.png” that includes the file identifier and indicates the storage location of the image. Thus, the user prompt application 102b2 may retrieve the file resource identifier based on identifying the file identifier within the file resource identifier.

As another example, a ninth figure in a product user guide document may have the corresponding file identifier “Product_UserGuide_Figure_9”. When the user prompt application 102b1 identifies this file identifier within the LLM 102b2 output, the application 102b1 retrieves the corresponding file resource identifier (e.g., “storage location/Product_UserGuide_Figure_9.png”) and converts the file identifier in the output data into this file resource identifier. In this example, the user prompt application 102b1 further converts this file resource identifier into an html image display tag (e.g., “<img src=”location: Product_UserGuide_Figure_8.png“>”) or other similar configuration(s) to display the image for the user.

In certain embodiments, the file resource identifier comprises a unique or self-defined identifier that replaces each respective non-textual data in the context of the file. In certain embodiments, the image, the audio file, the video file, the three-dimensional model, and/or any other suitable data types and/or the other non-textual data referenced by the file resource identifier comprises a standalone file (e.g., a .png file, a .gif file, a .jpeg file, a .wav file, an .aac file, an .mov file, a .wmv file). Additionally, or alternatively, the input prompt may include (i) one or more questions from one or more users that correspond to one or more documents and (ii) content associated with the question(s) (e.g., keywords, headings, titles, figure reference numbers, etc.). In some embodiments, the user prompt application 102b1 further generates an embedding (e.g., a vector, tensor) of (i) the request(s) input by the user(s) and determines one or more similarity values of the embedding(s) with one or more embeddings of text portions associated with one or more documents that may include and/or otherwise correspond with one or more images and/or other data types.

In some embodiments, the user prompt application 102b1 may include or access various multi-modal encoders to vectorize/embed the non-textual data into a shared embedding space to determine similarity values, generate one or more input prompts based on the similarity values, and input the input prompt(s) into the LLM 102b2. If the LLM 102b2 generates output data including a file identifier associated with an image, then the user prompt application 102b1 may proceed to retrieve the corresponding file resource identifier and/or other data and convert the file identifier in the output data to the file resource identifier and/or other data (e.g., html image display tags).

For example, an input prompt may indicate a user request for information associated with an entity (e.g., that owns/controls central server 102), such as an organizational chart indicating internal departmental structures and chains of command. In this example, the user prompt application 102b1 executes an embedding encoder to generate embeddings of the user's request and compares these embeddings with embeddings of stored or previously processed text data (e.g., .pdf (or other file type) text chunks stored in the application data 102b3). The user prompt application 102b1 determines similarity values between the embeddings generated for the user's request and embeddings of the previously-processed text data and can thereby determine which text chunks to include as part of the input prompt (textual data) for the LLM 102b2 based on the top p text chunks that have similarity values that, for example, meet or exceed a similarity value threshold, where p is a positive integer and the top p are the top p text chunks ranked by greatest similarity value that meets or exceeds a similarity value threshold. In some examples, the similarity values between two embeddings comprise a cosine similarity, a Euclidean distance, a Manhattan distance (L1 norm), a Jaccard similarity values, a Pearson Correlation Coefficient, and/or any other suitable similarity metric(s) or combinations thereof.

Additionally or alternatively, the user prompt application or the LLM may previously cluster (e.g., using k-means, density-based spatial clustering of applications with noise (DBSCAN)) the embeddings of the previously-processed text data and may determine that a first embedding generated from the user's request is similar to a previously-processed text embedding (or group of such embeddings) based at least in part on determining that the first embedding lies within a cluster or within a threshold distance (e.g., Euclidean distance) of a cluster. Regardless, the text chunks associated with previously-processed text embeddings or the previously-processed text embeddings determined to be similar to any of the request embeddings may be used to augment a prompt (e.g., as contextual data concatenated with the request text or as additional embeddings provided to) provided to the LLM 102b2 as input and which can be used to generate more relevant outputs in response to the user's request, including more accurate file identifiers. In some examples, the prompt provided to the LLM 102b2 may comprise the request text and any text chunk(s) determined to be associated therewith and/or request embedding(s) and any previously-processed text embedding(s) determined to be similar to the request embedding(s).

In certain embodiments, the user prompt application 102b1 determines an embedding (e.g., via an encoder) of a user request and a subset of similar embeddings from among a set of embeddings generated by the encoder using a set of text chunks associated with one or more files. The application 102b1 may determine to include a text chunk embedding in the subset of similar embeddings by determining that the embedding of the user request is within a threshold distance (e.g., cosine similarity, Euclidean distance, L1 norm, etc.) of the text chunk embedding. The application 102b1 may further provide, as input to the LLM 102b2, the user request embedding and the subset of similar embeddings and/or the user's request and a subset of text chunks associated with the subset of similar embeddings. In some embodiments, at least one text chunk of the subset of text chunks comprises a file identifier, and providing the subset of text chunks as input to the LLM 102b2 comprises providing a text chunk comprising the filing identifier as input.

The user prompt application 102b1 inputs the user's request (e.g., user-generated text) and any context data (e.g., contextually similar/relevant text chunks that may include file identifiers) into the LLM 102b2 as an input prompt (e.g., as textual data or as a set of embeddings) for processing by the LLM 102b2. Continuing the prior example, the application 102b1 executes the LLM 102b2 to generate output data based on the input prompt, and the output data may include a file identifier that was included in the input prompt and that is associated with a document that includes the organizational chart requested by the user. The user prompt application 102b1 may recognize/identify the file identifier, which links and/or otherwise keys the user prompt application 102b1 to retrieve the file resource identifier (e.g., from the application data 102b3). The user prompt application 102b1 then converts/replaces the file identifier in the output data to the file resource identifier and pushes the output data with the file resource identifier to the user computing device (e.g., 104) for viewing by the user. Of course, in certain examples, the application 102b1 may further convert the file resource identifier into an html image display tag or other suitable configuration that causes the user's device (e.g., computing device 104) to automatically retrieve and display the corresponding image. Some/all of these input prompts and/or output data may eventually be stored within the application data 102b3 and/or in an external storage location (e.g., external server 106).

As another example, a user using the computing device 104 may transmit an input prompt to the central server 102 indicating a request for information regarding scheduling an appointment to meet with a service provider that owns/hosts the central server 102. The user prompt application 102b1 receives this input prompt, determines additional content/contextual data to provide the LLM 102b1 via embeddings and similarity values, and applies the LLM 102b2 to the input prompt (e.g., user input prompt and additional content/contextual data) to generate output data. When analyzing the input prompt, the LLM 102b2 may determine that a portion (e.g., text chunk) of a document stored in the application data 102b3 or elsewhere (e.g., data set 106b1) that includes a file identifier is contextually relevant to the user's request. For example, the image associated with the file identifier may illustrate a sequence of steps the user should take to schedule an appointment with the service provider.

Thus, in the above example, the LLM 102b2 may include the file identifier (e.g., “Appointment_Scheduling_Guide_Figure 2”) in the output data that references the image and/or other non-textual data. The user prompt application 102b1 then identifies the file identifier in the output data, locates the file resource identifier (e.g., “https://storagelocation.com/Appointment_Scheduling_Guide_Figure 2.png”) referenced by the file identifier, and replaces the file identifier in the output data to the file resource identifier. In this example, the file resource identifier references an image, so the user prompt application 102b1 may convert the file resource identifier into an html image display tag (e.g., <img src=“https://storagelocation.com/Appointment_Scheduling_Guide_Figure 2.png” ), to display the corresponding image to the user. When the user thereafter receives the output data at the computing device 104 (e.g., presented via display 104d), the output data may include the image illustrating the sequence of steps to schedule an appointment with the service provider.

In certain examples, the LLM 102b2 may output data that comprises multiple file identifiers, and one or more of these file identifiers may be associated with a multimedia file (e.g., an .mp3 file, a. wav file, etc.). In these examples, the user prompt application 102b1 may retrieve each of the multiple file resource identifiers associated with the multiple file identifiers and may cause one or more of the multimedia files to be displayed to the user as part of the output data. For example, one of the multimedia files included in an LLM 102b2 output may be an .mp4 file including video data. The user prompt application 102b1 may cause the output data displayed to the user to include this .mp4 file, which may be played or presented in an embedded application responsive to user input indicating permission to play or present the multimedia file.

As mentioned, the LLM 102b2 is capable of generating these file identifiers as part of the output data because the user prompt application 102b1 includes the file identifiers as part of the inputs to the LLM 102b2. It is generally reasonable to assume that an image located within a file/document is contextually associated with some corresponding text in the document, and that these contextual associations are indicated/expressed in the document text. For example, a first image “FIG. 1” within a file may have contextually associated text within the document that is signaled by an example “FIG. 1 below illustrates this idea . . . ”, or “relationship between A and B is shown in FIG. 1.” Because these contextual associations are expressed in pure text, the user prompt application 102b1 can utilize the contextually relevant textual portions of the document to cause the LLM 102b2 to understand when the image or other non-textual data may be relevant to include as part of the output data. When the LLM 102b2 receives contextually relevant textual portions of file(s)/document(s) as part of an input prompt, the LLM 102b2 may include/utilize these textual portions (e.g., including one or more file identifiers) as part of the generated output data when responding to the user's question requires and/or would benefit from information included in the textual portions.

To generate the file identifiers to potentially include as inputs to the LLM 102b2, the user prompt application 102b1 evaluates the contextually relevant textual portions of the document (e.g., image title/label, corresponding paragraphs/sentences, file title) to determine a set of distinct, unique, and/or otherwise identifying terms that reference the non-textual data. For example, the “FIG. 1” in the previous example may be the first figure of a product user guide, and the user prompt application 102b1 may correspondingly generate/associate a file identifier for this “FIG. 1” that is “Product_UserGuide_Figure_1.”

The user prompt application 102b1 generally extracts and stores all images and/or other non-textual data from a specific file/document into a storage location/directory (e.g., application data 102b3, data set 106b1), and the file identifier indicates the file resource identifier, which functions as a link/key to each image or non-textual data. For example, the user prompt application 102b1 may receive a .pdf file related to orientation and/or other training(s) for new personnel of an entity that owns/hosts the central server 102. This .pdf file may include a variety of graphs, charts, illustrations, and/or other images that are intended to convey information to the personnel being trained. The user prompt application 102b1 may analyze the .pdf file, identify each of the graphs, charts, illustrations, and/or other images (i.e., the non-textual data) within the .pdf file, and extract all the non-textual data from the .pdf file. In certain embodiments, the user prompt application 102b1 utilizes optical character recognition (OCR), natural language processing (NLP), and/or any other suitable techniques or combinations thereof to identify and extract non-textual data from the .pdf file. Further, in some embodiments, the storage location for non-textual data comprises a vector database (e.g., as part of application data 102b3 and/or data set 106b1) storing vectors that encode file identifiers and relevant contextual data.

More specifically, the user prompt application 102b1 divides a received document into one or more chunks, and each chunk generally comprises a portion of text of the document. Certain chunks further comprise other data types, such as image data, video data, audio data, executable files, three-dimensional models, and/or other multimedia data. The application 102b1 may then extract the image and/or other multimedia data from the document and may determine (e.g., by an encoder model), based at least in part on the text portions included in each chunk, embeddings of the chunks. The application 102b1 may further store the image and/or other multimedia data and/or the embeddings in a storage location (e.g., application data 102b3). The application 102b1 may further detect that a portion of text from the document comprises a textual reference to the image and may determine the file identifier based at least in part on the reference. The application 102b1 may further determine a modified chunk by replacing the textual reference with the file identifier and may store the modified chunk in association with the first embedding. The application 102b1 may detect that the portion of text from the document comprises a textual reference to an image by executing a machine-learning model, such as a natural language processing (NLP) model, an LLM, and/or a set of regular expressions (regex).

In certain embodiments, the LLM 102b2 is stored in a remote location from the central server 102 (e.g., a cloud-based server). In these embodiments, the user prompt application 102b1 accesses the LLM 102b2 by transmitting inputs (e.g., input prompts) to the cloud-based server. The LLM 102b2 analyzes the inputs, generates outputs (e.g., text-based data including a file identifier), and the cloud-based server returns these outputs to the user prompt application 102b1. The user prompt application 102b1 then identifies the file identifier, retrieves the corresponding file resource identifier, and replaces the file identifier into the file resource identifier (and/or an html image display tag) for display to a user.

Generally speaking, machine learning may be implemented through machine learning methods and algorithms. In certain embodiments, the machine learning model(s) utilized as part of the central server 102 comprises the LLM 102b2 configured to determine output data based on input prompts that include (1) textual data from a user request/query and/or (2) contextual descriptions (e.g., text chunks) from an associated file/document and/or embeddings associated with the contextual descriptions. Additionally, or alternatively, the machine learning models described herein may utilize or include natural language processing (NLP) functionality. For example, the input prompts transmitted to the LLM 102b2 may include only textual data (i.e., text), and the LLM 102b2 may implement NLP algorithms/models to interpret the text included therein when determining the output data including file identifiers. Although in additional or alternate examples, the prompts may include additional or alternate modalities of input data, such as video data, audio data, three-dimensional model data, executable files, application files, and/or any other suitable data types.

More generally, the computing device 104 comprises any device that is associated with (e.g., owned and/or operated by) a particular entity that may provide data (e.g., input prompts) that is transmitted to and/or is otherwise accessible by the central server 102 and/or the external server 106 through the network 108. In certain embodiments, the input prompt(s) transmitted to and/or otherwise accessible by the central server 102 and/or the external server 106 comprises a question, a request, and/or other text-based comment related a file or other documents that are stored in a storage location as part of the application data 102b3 and/or the data set 106b1. This input prompt is to be evaluated by the central server 102 and/or the external server 106.

In some embodiments, the computing device 104 comprises a server or collection of servers, through which, one or more users submit input prompts to the central server 102 via individual computing devices connected to the computing device 104. However, in certain embodiments, the computing device 104 comprises a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 comprises a processor 104a, a memory 104b, a networking interface 104c, and a display 104d.

The computing device 104 is communicatively coupled to the central server 102 and/or the external server 106. For example, the computing device 104, the central server 102, and/or the external server 106 may communicate via USB, Bluetooth, Wi-Fi Direct, Near Field Communication (NFC), etc. For example, the central server 102 may transmit output data indicating responses to the input prompt that include an image and/or other non-textual data, and/or any other values or combinations thereof to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106b1 including data from the computing device 104 and/or the central server 102. In one such example, the external server 106 comprises a server located in and/or otherwise associated with a service provider, and the data set 106b1 comprises a repository for infrequently accessed training materials and/or marketing/promotional materials in memory 106b. As another example, the external server 106 serves as a database for some or all the application data 102b3. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid-state memory) and may store one or more applications, modules, and/or models, such as the user prompt application 102b1.

The networking interface 102c may enable the central server 102 to communicate with the computing device 104, the external server 106, and/or any other suitable devices or combinations thereof. More specifically, the networking interface 102c enables the central server 102 to communicate with each component of the example computing system 100 across the network 108 through their respective networking interfaces 104c, 106c. The networking interfaces 102c, 104c, 106c may support wired or wireless communications, such as USB, Bluetooth, Wi-Fi Direct, Near Field Communication (NFC), etc. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 comprises multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example Language Model Multimedia Data Output Workflows

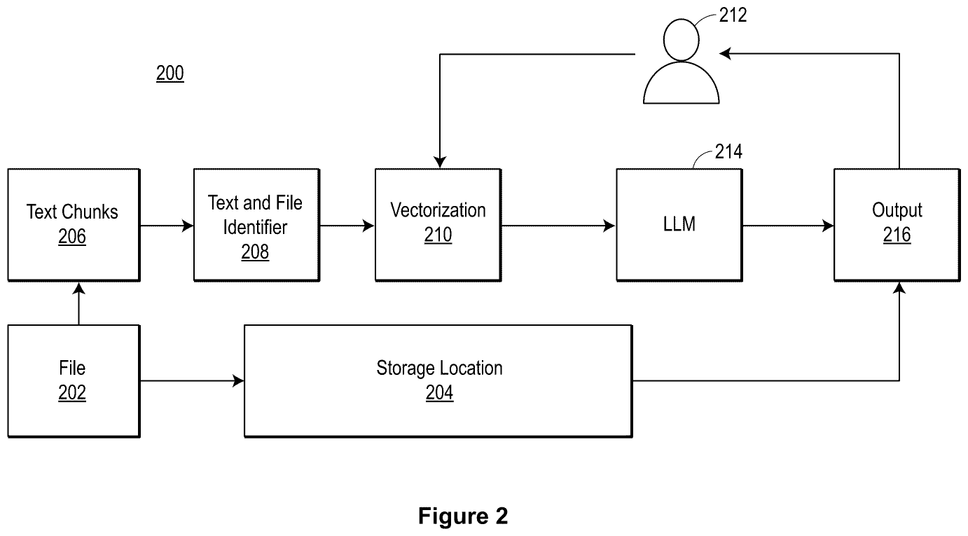

FIG. 2 depicts an example language model multimedia data output workflow 200, in accordance with various embodiments described herein. The example language model multimedia data output workflow 200 broadly illustrates a set of actions, which may be performed by central server 102 (e.g., processor 102a and/or other components of central server 102) of FIG. 1, for example, to generate/determine output data including image data or other non-textual data, file identifiers, file resource identifiers, context data, embeddings, similarity values, and/or to cause the output data to be displayed to a user. The example language model multimedia data output workflow 200 illustrated in FIG. 2 is for the purposes of discussion only, and additional/alternative language model multimedia output sequences may also, or instead, be utilized.

The language model multimedia data output workflow 200 comprises analyzing a data file 202 to extract text data, image data and/or other non-textual data from the data file. For example, the data file 202 may be a .pdf file of a user operation manual for a device and may include multiple illustrations of the device and corresponding operations. The systems described herein may extract the image data and/or other non-textual data from the .pdf file 202 and store the image data and/or other non-textual data in a storage location 204.

The systems of the present disclosure process the extracted non-textual data in conjunction with corresponding textual data (e.g., text chunks) (block 206). Continuing the above example, a first figure from the user operation manual may include a corresponding description in the manual stating that “FIG. 1 illustrates a first operating mode of the device.” The systems of the present disclosure may have already extracted the first figure from the user operation manual or may extract the first figure in tandem with evaluating the corresponding description. Regardless, the systems of the present disclosure may interpret this description using NLP, OCR, and/or any other suitable technique(s) or combinations thereof to determine that the “FIG. 1”included in the description references the first figure image.

With a reference to the non-textual data indicated in the textual data, the systems of the present disclosure then generate a file identifier for the non-textual data and replace the reference to the non-textual data with the file identifier (block 208). The systems of the present disclosure determine/generate a file identifier for the non-textual data that indicates (e.g., textually references), is linked to, and/or is otherwise associated with a file resource identifier that indicates/specifies the location (e.g., file path) of the non-textual data in the storage location 204. In this manner, the systems of the present disclosure may readily locate non-textual data included and/or otherwise indicated in output data of an LLM (e.g., LLM 214) by confirming that the file identifier indicated in the output data identifies the file resource identifier for non-textual data stored in the storage location 204. In the prior example, the systems of the present disclosure may generate a file identifier for a first figure from the user operation manual that is “User_Operation_Manual_Figure_1,” and this file identifier may reference an file resource identifier (e.g., “storagelocation/User_Operation_Manual_Figure_1.png,”) that indicates the file path to the first figure in the storage location 204.

The systems of the present disclosure may replace the “FIG. 1” in the corresponding description in the user operation manual with the file identifier. After the replacement, the corresponding description reads “User_Operation_Manual_Figure_1 illustrates a first operating mode of the device.” In certain embodiments, the systems of the present disclosure use corresponding descriptions that are modified to include the file indicator as portions of input prompts to the LLM 214 to cause the LLM 214 to associate the file indicator with the relevant textual data in the description.

The workflow 200 further comprises vectorizing (i.e., encoding) the text chunks including file identifiers and determining similarity values with embeddings of a user's 212 request (e.g., questions, remarks, etc.) (block 210). The text chunks including file identifiers and the user's 212 request are generally vectorized into a common vector space, so that when new requests are received from the user 212, the embeddings of the user's 212 new requests can be quickly compared with the text chunks and file identifiers in the common vector space to determine the similarity values. In particular, block 210 may comprise determining the top p text chunks that have an embedding with a similarity value meeting or exceeding a similarity value threshold when compared to the user's 212 request embedding(s).

When the systems described herein determine the similarity values at block 210, the systems may output an input prompt for input into the LLM 214. This input prompt generally comprises the text versions of the user's 212 request and any text chunks (potentially including file identifiers) corresponding to an embedding with a similarity value that meets or exceeds a similarity value threshold (e.g., at least 0.5, 0.8, 0.95, etc.). In some examples, the input prompt comprises embeddings of the user's 212 request and/or embeddings of contextually similar text chunks. In certain embodiments, the embeddings of the text chunks and file identifiers are stored in a vector database for future/repeated use.

For example, the user 212 may input a request stating, “How does this device operate in the first mode of operation?” The systems of the present disclosure may receive this user 212 request, generate a vector representation of the user 212 request, and compare the vector representation to vector representations of text chunks and file identifiers, for example, stored in the vector database. The systems of the present disclosure may identify the above-referenced text chunk and file identifier (i.e., “User_Operation_Manual_Figure_1 illustrates a first operating mode of the device”) as satisfying a similarity/distance threshold or other suitable threshold relative to the user request embedding and may subsequently input both the user request and the text chunk and file identifier and/or the corresponding embeddings into the LLM 214 as an input prompt.

The LLM 214 then generates output data based on the input prompt, which comprises textual data. The systems of the present disclosure then evaluate the output data to identify a file identifier in the output data. When the systems of the present disclosure identify a file identifier, the systems of the present disclosure retrieve the file resource identifier associated with the file identifier and convert the file identifier in the output to the file resource identifier (block 216). Continuing the prior example, the LLM 214 may generate output data that includes the file identifier “User_Operation_Manual_Figure_1.” The systems of the present disclosure analyze this output data, identify the file identifier, and retrieve the file resource identifier (e.g., “storagelocation/User_Operation_Manual_Figure_1.png,”) of the first figure. The systems of the present disclosure then replace the file identifier in the output data from the LLM 214 with the file resource identifier and may additionally convert the file resource identifier into an html image display tag (e.g., <img src=“storagelocation/User_Operation_Manual_Figure_1.png”>) linking to the first figure. In either case, the output data is then output to the user 212 for viewing by the user.

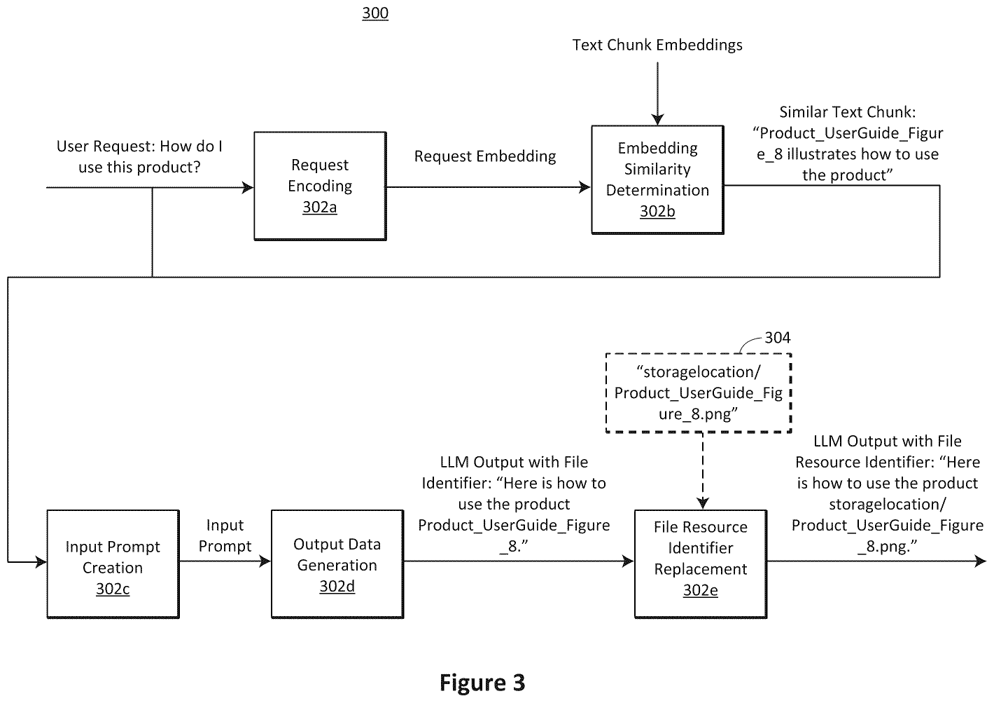

FIG. 3 depicts an example language model output data generation and multimedia data replacement process 300, in accordance with various embodiments described herein. The example language model output data generation and multimedia data replacement process 300 comprises blocks 302a-302e, which generally represent actions performed as part of the execution of the user prompt application 102b1 and/or the LLM 102b2. However, it should be understood that any components of the example computing system 100 and/or any other components described herein may perform functions and/or otherwise contribute to the actions represented by blocks 302a-302e.

The process 300 begins at block 302a, where an encoder receives a user request and generates a request embedding of the user's request. As illustrated in FIG. 3, the user input prompt states, “How do I use this product?” The encoder generally encodes the user's request into a shared vector space with text embeddings that represent text chunks (and potentially file identifiers) from various files that may be relevant to the user's request. The process 300 further comprises comparing the user's request embedding to text chunk embeddings to determine which text chunks are contextually similar to the user's request, and should be included or referenced (e.g., via a text embedding) in the input prompt of the LLM.

The process 300 further comprises creating an input prompt for the LLM based on the user's request and any similar text chunks and/or files associated therewith (block 302c). As illustrated in FIG. 3, a similar text chunk used to create the input prompt includes a file indicator and states that, “Product_UserGuide_Figure_8 illustrates how to use this product.” Block 302c may comprise formatting the user request with the text chunk to create a single input prompt, and/or may include larger portions of the file (e.g., the text of the entire file) from which the text chunk was extracted to ensure the LLM has sufficient context to generate a meaningful response to the user's request.

At block 302d, the process 300 further comprises an LLM (e.g., LLM 102b2) generating output data that includes a file identifier. The LLM output states, “Here is how to use the product Product_UserGuide_Figure_8,” where the file identifier indicates that an image (e.g., FIG. 8) from the file referenced by the file identifier should be included as part of the data displayed to the user.

This output data is received at block 302e, where a user prompt application (e.g., 102b1) analyzes the output data to identify the file identifier (“Product_UserGuide_Figure_8”) within the output data. In response, the user prompt application locate/retrieves a file resource identifier 304 (e.g., “storagelocation/Product_UserGuide_Figure_8.png”). This file resource identifier 304 identifies the location of the relevant FIG. 8 from the product user guide. The user prompt application replaces the file identifier (“Product_UserGuide_Figure_8”) in the output data with the file resource identifier 304, such that the output data may include the statement, “Here is how to use the product “storagelocation/Product_UserGuide_Figure_8.png.” Of course, the user prompt application may also replace the file resource identifier 304 with an html image display tag (e.g., “<img src=“storagelocation/Product_UserGuide_Figure_8.png>”) to cause the users'device to automatically display the relevant FIG. 8 image. Regardless, the user prompt application then causes the output data to be displayed for viewing by the user (e.g., via display 104d of computing device 104).

### Example Computer-Implemented Methods

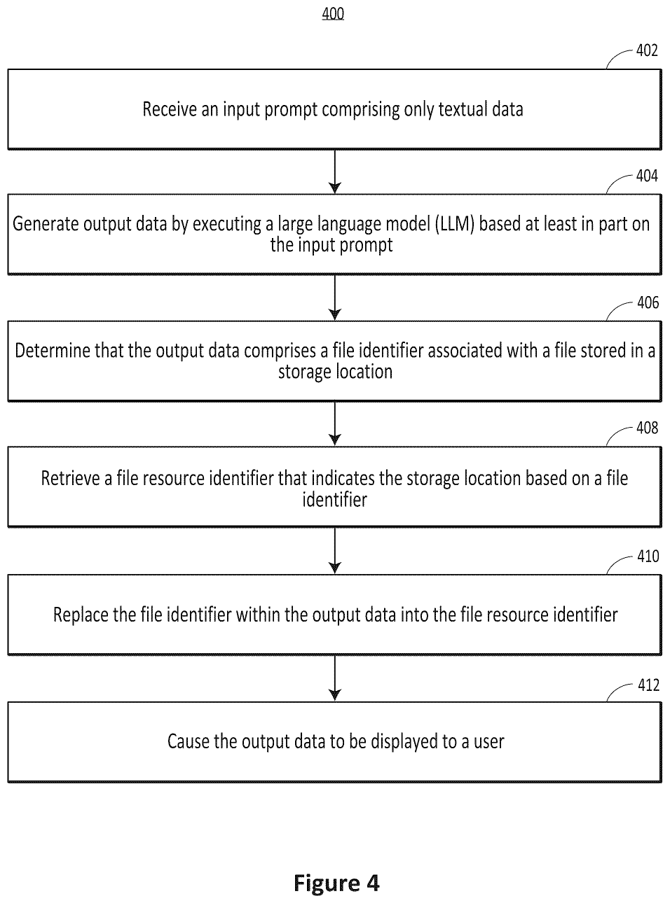

FIG. 4 depicts a flow diagram representing an example computer-implemented method 400, in accordance with various embodiments described herein. The method 400 may be implemented by one or more processors of the example computing system 100, such as the processor 102a of central server 102 (e.g., by user prompt application 102b1), for example.

The method 400 comprises receiving, by one or more processors, an input prompt comprising textual data (block 402). The method 400 further comprises generating, by a large language model executed by the one or more processors and based at least in part on the input prompt, output data (block 404). The method 400 further comprises determining that the output data comprises a file identifier associated with a file stored in a storage location (block 406).

The method 400 further comprises retrieving, based on the file identifier, a file resource identifier that indicates the storage location (block 408). The method 400 further comprises replacing the file identifier within the output data into the file resource identifier (block 410). The method 400 further comprises causing the output data to be displayed (block 412). Causing the output data to be displayed comprises causing an image associated with the file resource identifier to be displayed.

In certain embodiments, the output data generated by the LLM further comprises a second file identifier associated with a multimedia file, and the method 400 further comprises retrieving a second file resource identifier based at least in part on the second file identifier. In some embodiments, causing the output data to be displayed further comprises causing the multimedia file to be displayed or wherein causing the output data to be displayed further comprises the multimedia file to be played or presented in an embedded application responsive to user input indicating permission to play or present the multimedia file.

In some embodiments, the method 400 further comprises dividing a document into one or more chunks, wherein a first chunk comprises a portion of text of the document and the image; determining, by an encoder model based at least in part on the portion of text, a first embedding; extracting, by the one or more processors, the image from the document including the image; storing, by the one or more processors, the image in the storage location; and storing, by the one or more processors, the first embedding in association with the first chunk.

In certain embodiments, the method 400 further comprises detecting that the portion of text comprises a textual reference to the image; determining the file identifier based at least in part on the textual reference; determining a first modified chunk by replacing the textual reference with the file identifier; and storing the first modified chunk in association with the first embedding.

In certain embodiments, generating the output data further comprises determining, by an encoder and based at least in part on the input prompt, a first embedding; determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and providing, as input to the large language model, at least one of the first embedding and the subset of similar embeddings or the input prompt and a subset of text chunks associated with the subset of similar embeddings, at least one text chunk of the subset of text chunks comprising the file identifier.

In some embodiments, providing the subset of text chunks as input to the large language model comprises providing a first text chunk comprising the file identifier as input.

In certain embodiments, the file resource identifier comprises a uniform resource identifier (URI) or a uniform resource locator (URL).

Of course, it is to be appreciated that the actions of the method 400 may be performed any suitable number of times, and that the actions described in reference to the method 400 may be performed in any suitable order.

### EXAMPLES

Example 1. A computer-implemented method comprising: receiving, by one or more processors, an input prompt comprising textual data; generating, by a large language model executed by the one or more processors and based at least in part on the input prompt, output data; determining that the output data comprises a file identifier associated with a file stored in a storage location; retrieving, by the one or more processors and based on the file identifier, a file resource identifier that indicates the storage location; converting, by the one or more processors, the file identifier within the output data into the file resource identifier; and causing, by the one or more processors, the output data to be displayed, wherein causing the output data to be displayed comprises causing an image associated with the file resource identifier to be displayed.

Example 2. The computer-implemented method of example 1, wherein: the output data generated by the large language model further comprises a second file identifier associated with a multimedia file; the computer-implemented method further comprises retrieving a second file resource identifier based at least in part on the second file identifier; and causing the output data to be displayed further comprises causing the multimedia file to be displayed or wherein causing the output data to be displayed further comprises the multimedia file to be played or presented in an embedded application responsive to user input indicating permission to play or present the multimedia file.

Example 3. The computer-implemented method of example 1 or 2, further comprising: dividing a document into one or more chunks, wherein a first chunk comprises a portion of text of the document and the image; determining, by an encoder model based at least in part on the portion of text, a first embedding; extracting, by the one or more processors, the image from the document including the image; storing, by the one or more processors, the image in the storage location; and storing, by the one or more processors, the first embedding in association with the first chunk.

Example 4. The computer-implemented method of example 3, further comprising: detecting that the portion of text comprises a textual reference to the image; determining the file identifier based at least in part on the textual reference; determining a first modified chunk by replacing the textual reference with the file identifier; and storing the first modified chunk in association with the first embedding.

Example 5. The computer-implemented method of any of examples 1-4, wherein generating the output data further comprises: determining, by an encoder and based at least in part on the input prompt, a first embedding; determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and providing, as input to the large language model, at least one of the first embedding and the subset of similar embeddings or the input prompt and a subset of text chunks associated with the subset of similar embeddings, at least one text chunk of the subset of text chunks comprising the file identifier.

Example 6. The computer-implemented method of example 5, wherein providing the subset of text chunks as input to the large language model comprises providing a first text chunk comprising the file identifier as input.

Example 7. The computer-implemented method of any of examples 1-6, wherein the file resource identifier is a uniform resource identifier (URI) or a uniform resource locator (URL).

Example 8. A system comprising: one or more processors; and one or more memories storing processor-executable instructions that, when executed by the one or more processors, cause the one or more processors to perform operations comprising: receiving an input prompt comprising textual data; generating, by a large language model (LLM) based at least in part on the input prompt, output data including a file identifier associated with a file stored in a storage location; retrieving, based on the file identifier, a file resource identifier that indicates the storage location; replacing the file identifier within the output data with the file resource identifier; and causing the output data to be displayed to a user, wherein causing the output data to be displayed comprises causing an image associated with the file resource identifier to be displayed.

Example 9. The system of example 8, wherein: the output data generated by the large language model further comprises a second file identifier associated with a multimedia file; and the processor-executable instructions, when executed, further cause the one or more processors to perform operations comprising: retrieving a second file resource identifier based at least in part on the second file identifier; and causing the multimedia file to be displayed or causing the multimedia file to be played or presented in an embedded application responsive to user input indicating permission to play or present the multimedia file.

Example 10. The system of example 8 or 9, wherein the processor-executable instructions, when executed, further cause the one or more processors to perform operations comprising: dividing a document into one or more chunks, wherein a first chunk comprises a portion of text of the document and the image; determining, by an encoder model based at least in part on the portion of text, a first embedding; extracting the image from the document including the image; storing the image in the storage location; and storing the first embedding in association with the first chunk.

Example 11. The system of example 10, wherein the processor-executable instructions, when executed, further cause the one or more processors to perform operations comprising: detecting that the portion of text comprises a textual reference to the image; determining the file identifier based at least in part on the textual reference; determining a first modified chunk by replacing the textual reference with the file identifier; and storing the first modified chunk in association with the first embedding.

Example 12. The system of any of examples 8-11, wherein the processor-executable instructions, when executed, further cause the one or more processors to generate the output data by: determining, by an encoder and based at least in part on the input prompt, a first embedding; determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and providing, as input to the large language model, at least one of the first embedding and the subset of similar embeddings or the input prompt and a subset of text chunks associated with the subset of similar embeddings, at least one text chunk of the subset of text chunks comprising the file identifier.

Example 13. The system of example 12, wherein providing the subset of text chunks as input to the large language model comprises providing a first text chunk comprising the file identifier as input.

Example 14. The system of any of examples 8-13, wherein the file resource identifier is a uniform resource identifier (URI) or a uniform resource locator (URL).

Example 15. One or more non-transitory computer-readable media storing processor-executable instructions that, when executed by one or more processors, cause the one or more processors to perform operations comprising: receiving an input prompt comprising textual data; generating, by a large language model (LLM) based at least in part on the input prompt, output data including a file identifier associated with a file stored in a storage location; retrieving, based on the file identifier, a file resource identifier that indicates the storage location; replacing the file identifier within the output data into the file resource identifier; and causing the output data to be displayed to a user, wherein causing the output data to be displayed comprises causing an image associated with the file resource identifier to be displayed.

Example 16. The one or more non-transitory computer-readable media of example 15, wherein: the output data generated by the large language model further comprises a second file identifier associated with a multimedia file; and the processor-executable instructions, when executed, further cause the one or more processors to perform operations comprising: retrieving a second file resource identifier based at least in part on the second file identifier; and causing the multimedia file to be displayed or cause the multimedia file to be played or presented in an embedded application responsive to user input indicating permission to play or present the multimedia file.

Example 17. The one or more non-transitory computer-readable media of example 15 or 16, wherein the processor-executable instructions, when executed, further cause the one or more processors to perform operations comprising: dividing a document into one or more chunks, wherein a first chunk comprises a portion of text of the document and the image; determining, by an encoder model based at least in part on the portion of text, a first embedding; extracting the image from the document including the image; storing the image in the storage location; and storing the first embedding in association with the first chunk.

Example 18. The one or more non-transitory computer-readable media of example 17, wherein the processor-executable instructions, when executed, further cause the one or more processors to perform operations comprising: detecting that the portion of text comprises a textual reference to the image; determining the file identifier based at least in part on the textual reference; determining a first modified chunk by replacing the textual reference with the file identifier; and storing the first modified chunk in association with the first embedding.

Example 19. The one or more non-transitory computer-readable media of any of examples 15-18, wherein the processor-executable instructions, when executed, further cause the one or more processors to perform operations comprising: determining, by an encoder and based at least in part on the input prompt, a first embedding; determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and providing, as input to the large language model, at least one of the first embedding and the subset of similar embeddings or the input prompt and a subset of text chunks associated with the subset of similar embeddings, at least one text chunk of the subset of text chunks comprising the file identifier.

Example 20. The one or more non-transitory computer-readable media of example 19, wherein providing the subset of text chunks as input to the large language model comprises providing a first text chunk comprising the file identifier as input.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, an input prompt comprising textual data;
generating, by a large language model executed by the one or more processors and based at least in part on the input prompt, output data;
determining that the output data comprises a file identifier associated with a file stored in a storage location;
retrieving, by the one or more processors and based on the file identifier, a file resource identifier that indicates the storage location;
replacing, by the one or more processors, the file identifier within the output data into the file resource identifier; and
causing, by the one or more processors, the output data to be displayed, wherein causing the output data to be displayed comprises causing an image associated with the file resource identifier to be displayed.

2. The computer-implemented method of claim 1, wherein:
the output data generated by the large language model further comprises a second file identifier associated with a multimedia file;
the computer-implemented method further comprises retrieving a second file resource identifier based at least in part on the second file identifier; and
causing the output data to be displayed further comprises causing the multimedia file to be displayed or wherein causing the output data to be displayed further comprises the multimedia file to be played or presented in an embedded application responsive to user input indicating permission to play or present the multimedia file.

3. The computer-implemented method of claim 1, further comprising:
dividing a document into one or more chunks, wherein a first chunk comprises a portion of text of the document and the image;
determining, by an encoder model based at least in part on the portion of text, a first embedding;
extracting, by the one or more processors, the image from the document including the image;
storing, by the one or more processors, the image in the storage location; and
storing, by the one or more processors, the first embedding in association with the first chunk.

4. The computer-implemented method of claim 3, further comprising:
detecting that the portion of text comprises a textual reference to the image;
determining the file identifier based at least in part on the textual reference;
determining a first modified chunk by replacing the textual reference with the file identifier; and
storing the first modified chunk in association with the first embedding.

5. The computer-implemented method of claim 1, wherein generating the output data further comprises:
determining, by an encoder and based at least in part on the input prompt, a first embedding;
determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and
providing, as input to the large language model, at least one of the first embedding and the subset of similar embeddings or the input prompt and a subset of text chunks associated with the subset of similar embeddings, at least one text chunk of the subset of text chunks comprising the file identifier.

6. The computer-implemented method of claim 5, wherein providing the subset of text chunks as input to the large language model comprises providing a first text chunk comprising the file identifier as input.

7. The computer-implemented method of claim 1, wherein the file resource identifier is a uniform resource identifier (URI) or a uniform resource locator (URL).

8. A system comprising:
one or more processors; and
one or more memories storing processor-executable instructions that, when executed by the one or more processors, cause the one or more processors to perform operations comprising:
receiving an input prompt comprising textual data;
generating, by a large language model (LLM) based at least in part on the input prompt, output data including a file identifier associated with a file stored in a storage location;
retrieving, based on the file identifier, a file resource identifier that indicates the storage location;
replacing the file identifier within the output data with the file resource identifier; and
causing the output data to be displayed to a user, wherein causing the output data to be displayed comprises causing an image associated with the file resource identifier to be displayed.

9. The system of claim 8, wherein:
the output data generated by the large language model further comprises a second file identifier associated with a multimedia file; and
the processor-executable instructions, when executed, further cause the one or more processors to perform operations comprising:
retrieving a second file resource identifier based at least in part on the second file identifier; and
causing the multimedia file to be displayed or causing the multimedia file to be played or presented in an embedded application responsive to user input indicating permission to play or present the multimedia file.

10. The system of claim 8, wherein the processor-executable instructions, when executed, further cause the one or more processors to perform operations comprising:
dividing a document into one or more chunks, wherein a first chunk comprises a portion of text of the document and the image;
determining, by an encoder model based at least in part on the portion of text, a first embedding;
extracting the image from the document including the image;
storing the image in the storage location; and
storing the first embedding in association with the first chunk.

11. The system of claim 10, wherein the processor-executable instructions, when executed, further cause the one or more processors to perform operations comprising:
detecting that the portion of text comprises a textual reference to the image;
determining the file identifier based at least in part on the textual reference;
determining a first modified chunk by replacing the textual reference with the file identifier; and
storing the first modified chunk in association with the first embedding.

12. The system of claim 8, wherein the processor-executable instructions, when executed, further cause the one or more processors to generate the output data by:
determining, by an encoder and based at least in part on the input prompt, a first embedding;
determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and
providing, as input to the large language model, at least one of the first embedding and the subset of similar embeddings or the input prompt and a subset of text chunks associated with the subset of similar embeddings, at least one text chunk of the subset of text chunks comprising the file identifier.

13. The system of claim 12, wherein providing the subset of text chunks as input to the large language model comprises providing a first text chunk comprising the file identifier as input.

14. The system of claim 8, wherein the file resource identifier is a uniform resource identifier (URI) or a uniform resource locator (URL).

15. One or more non-transitory computer-readable media storing processor-executable instructions that, when executed by one or more processors, cause the one or more processors to perform operations comprising:
receiving an input prompt comprising textual data;
generating, by a large language model (LLM) based at least in part on the input prompt, output data including a file identifier associated with a file stored in a storage location;
retrieving, based on the file identifier, a file resource identifier that indicates the storage location;
replacing the file identifier within the output data into the file resource identifier; and
causing the output data to be displayed to a user, wherein causing the output data to be displayed comprises causing an image associated with the file resource identifier to be displayed.

16. The one or more non-transitory computer-readable media of claim 15, wherein:
the output data generated by the large language model further comprises a second file identifier associated with a multimedia file; and
the processor-executable instructions, when executed, further cause the one or more processors to perform operations comprising:
retrieving a second file resource identifier based at least in part on the second file identifier; and
causing the multimedia file to be displayed or cause the multimedia file to be played or presented in an embedded application responsive to user input indicating permission to play or present the multimedia file.

17. The one or more non-transitory computer-readable media of claim 15, wherein the processor-executable instructions, when executed, further cause the one or more processors to perform operations comprising:
dividing a document into one or more chunks, wherein a first chunk comprises a portion of text of the document and the image;
determining, by an encoder model based at least in part on the portion of text, a first embedding;
extracting the image from the document including the image;
storing the image in the storage location; and
storing the first embedding in association with the first chunk.

18. The one or more non-transitory computer-readable media of claim 17, wherein the processor-executable instructions, when executed, further cause the one or more processors to perform operations comprising:
detecting that the portion of text comprises a textual reference to the image;
determining the file identifier based at least in part on the textual reference;
determining a first modified chunk by replacing the textual reference with the file identifier; and
storing the first modified chunk in association with the first embedding.

19. The one or more non-transitory computer-readable media of claim 15, wherein the processor-executable instructions, when executed, further cause the one or more processors to perform operations comprising:
determining, by an encoder and based at least in part on the input prompt, a first embedding;
determining a subset of similar embeddings from among a set of embeddings generated by the encoder using a set of text chunks associated with one or more files, wherein determining to include a first similar embedding in the subset of similar embeddings comprises determining that the first embedding is within a threshold distance of the first similar embedding; and
providing, as input to the large language model, at least one of the first embedding and the subset of similar embeddings or the input prompt and a subset of text chunks associated with the subset of similar embeddings, at least one text chunk of the subset of text chunks comprising the file identifier.

20. The one or more non-transitory computer-readable media of claim 19, wherein providing the subset of text chunks as input to the large language model comprises providing a first text chunk comprising the file identifier as input.
